(19) United States
(12) Patent Application Publication
(10) Pub. No.: US 2018/0262659 A1
(43) Pub. Date: Sep. 13, 2018

(54) DEVICE MOBILITY IN DIGITAL VIDEO PRODUCTION SYSTEM

(71) Applicant: SLING MEDIA PVT LTD, Bengaluru (IN)

(72) Inventors: Gajanan HEGDE, Karnataka (IN); Rakesh Eluvan PERIYAELUVAN, Bangalore (IN)

(73) Assignee: SLING MEDIA PVT LTD, Bengaluru (IN)

(21) Appl. No.: 15/920,342

(22) Filed: Mar. 13, 2018

(30) Foreign Application Priority Data
Mar. 13, 2017 (IN) 201741008644

(51) Int. Cl. H04N 5/222; G11B 27/031; H04N 5/232

(52) U.S. Cl. CPC H04N 5/2228; H04N 5/23203; G11B 27/031

(57) ABSTRACT

Systems, devices and processes improve the reliability of wireless communications within a video production system by providing a map or other graphical interface showing the relative locations of video capture devices, access points and/or other network devices. The graphical presentation can be used to provide instructions to direct the manual or automatic changing of positions to thereby improve signal quality for the device.

### PRIORITY CLAIM

This application claims priority of India Provisional Application Serial No. 201741008644, which was filed on 13 Mar. 2017 and is incorporated herein by reference.

### TECHNICAL FIELD

The following discussion generally relates to the production of digital video programming. More particularly, the following discussion relates to mobility of video capture devices and/or encoding and/or mixing devices used in the production of digital video programming.

### BACKGROUND

Recent years have seen an explosion in the creation and enjoyment of digital video content. Millions of people around the world now carry mobile phones, cameras or other devices that are capable of capturing high quality video and/or of playing back video streams in a convenient manner. Moreover, Internet sites such as YOUTUBE have provided convenient and economical sharing of live-captured video, thereby leading to an even greater demand for live video content.

More recently, video production systems have been created that allow groups of relatively non-professional users to capture one or more video feeds, to select one of the video feeds for an output stream, and to thereby produce a professional-style video of the output stream for viewing, sharing, publication, archiving and/or other purposes. Many of these systems rely upon Wi-fi, Bluetooth and/or other wireless communications for sharing of video feeds, control instructions and the like. The strength and reliability of wireless communications can vary widely, however, depending the relative locations of the transmitting and receiving devices, as well as upon environmental conditions, RF interference, obstructing walls or other objects and/or any number of other factors.

It is therefore desirable to create systems and methods that improve communications and reliability within a video production system. Other desirable features and characteristics will become apparent from the subsequent detailed description and the appended claims, taken in conjunction with the accompanying drawings and this background section.

### BRIEF SUMMARY

Various embodiments provide systems, devices and processes to improve the reliability of wireless communications within a video production system by providing a map or other graphical interface showing the relative locations of video capture devices, access points and/or other network devices operating within the video production system. The graphical presentation can be used to direct camera operators or other users to change positions and thereby improve their signal qualities. Further embodiments could automatically determine that a network node (e.g., a client or server) could improve its signal by moving to a different location. This new location could be determined in any manner, and may be constrained by various factors. Even further embodiments could direct a drone, robot or other motorized vehicle associated with the camera, access point or other networked device to automatically relocate to an improved location, as appropriate.

A first example embodiment provides an automated process executable by a video production device that produces a video production stream of an event occurring within a physical space from a plurality of video input streams that are each captured by different video capture devices located within the physical space. The automated process suitably comprises: receiving, from each of the different video capture devices, the video input stream obtained from the video capture device and location information describing a current location of the video capture device; presenting a first output image by the video production device that graphically represents the current locations of each of the video capture devices operating within the physical space; presenting a second output image by the video production device that presents the video input streams from at least some of the different video capture devices; receiving inputs from a user of the video production device to select one of the video input streams for inclusion in the video production stream; and responding to the inputs from the user of the video production device to create the video production stream as an output for viewing.

A further example may comprise analyzing the current locations of the video capture devices to determine an optimal location of the video production device relative to the video capture devices, and wherein the first output image comprises an indication of the optimal location within the physical space.

The above examples may further comprise directing a movement of the video production device from a current position to the optimal position within the physical environment.

In some examples, the optimal location is based upon a centroid of the distances to the different video capture devices.

The analyzing may further comprise identifying a restricted area in the physical space in which the video production device is not allowed to enter. The restricted area may be defined, for example, in terms of a three dimensional space having a minimum height so that the video production device is allowed to enter the restricted area above the minimum height. The first and second output images may both be presented within the same display screen, or the first and second output images are presented in separate display screens.

The video production system may comprise a processor, memory and display, wherein the processor executes program logic stored in the memory to generate a user interface on the display that comprises the first and second output images.

In another embodiment, a video production system for producing a video production stream of an event occurring within a physical space is provided. The video production system suitably comprises: a plurality of video capture devices located within the physical space, wherein each of the video capture devices is configured to capture an input video stream; an access point configured to establish a wireless communications connection with each of the video capture devices; and a video production device in communication with the access point to receive, from each of the plurality of video capture devices, the input video stream and location information describing a location of the video capture device within the physical environment. The video production device is further configured to present an interface on a display that comprises a first output image that graphically represents the current locations of each of the video capture devices operating within the physical space and a second output image by that presents the video input streams from at least some of the video capture devices.

In some further embodiments, the video production device is further configured to receive inputs from a user of the video production device to select one of the video input streams for inclusion in the video production stream, and to respond to the inputs from the user of the video production device to create the video production stream as an output for viewing.

The video production device may be further configured to analyze the current locations of the video capture devices to determine an optimal location of the video production device relative to the video capture devices, and wherein the first output image comprises an indication of the optimal location within the physical space.

The above embodiments may further comprise directing a movement of the video production device from a current position to the optimal position within the physical environment. The optimal location may be based upon a centroid of the distances to the different video capture devices.

In any of the above examples, the video production system may be further configured to determine an optimal location of at least one of the video capture devices based upon the location information and a location of the access point, and to provide an instruction to the video capture device directing the video capture device toward the optimal location of the video capture device.

Various additional examples, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a diagram of an example interface for displaying camera, encoder and/or other device locations;

FIG. 2 is a diagram of an example system for encoding, producing and distributing live video content;

FIG. 3 is a flowchart showing various processes executable by computing devices operating within a video production system.

### DETAILED DESCRIPTION

The following detailed description of the invention is intended to provide various examples, but it is not intended to limit the invention or the application and uses of the invention. Furthermore, there is no intention to be bound by any theory presented in the preceding background or the following detailed description.

Various embodiments improve operation of a video production system by gathering information about the location and/or communication quality of video capture devices operating within a physical environment. This information may be compiled into a graphical or other interface for presentation to the producer or another user. Some implementations may additionally recommend an improved location for a camera, access point or other network component. Further embodiments could additionally control a drone, robot or vehicle associated with a camera, access point and/or other communicating component so that the component is automatically moved to a different location that provides better communications to other component, and/or better coverage of the event. These aspects may be modified, omitted and/or enhanced as desired across a wide array of alternate but equivalent embodiments.

The general concepts described herein may be implemented in any video production context, especially the capture and encoding or transcoding of live video. For convenience of illustration, the following discussion often refers to a video production system in which one or more live video streams are received from one or more cameras or other capture devices via a wireless network to produce an output video stream for publication or other sharing. Equivalent embodiments could be implemented within other contexts, settings or applications as desired.

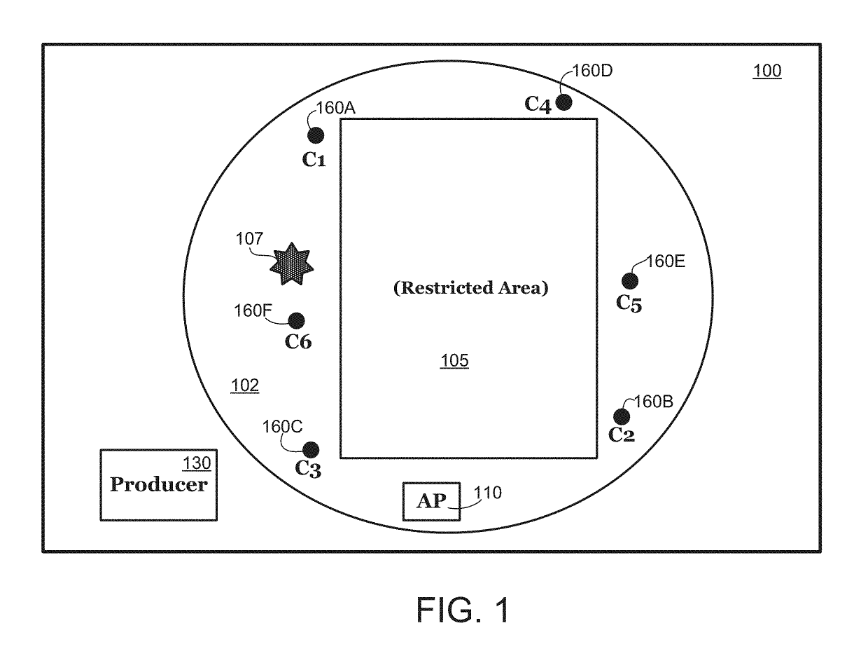

Turning now to the drawings and with initial reference to FIG. 1, a video production system suitably includes an encoder or other access point device 110, one or more cameras or other video capture devices 160A-E, and a control device 130 that are all located within network communication range within a physical environment 102. In the example of FIG. 1 (and frequently discussed below), a network access point device 110 also provides video encoding/transcoding functionality, so the terms “encoder device” and “access point device” are often used interchangeably. Equivalent embodiments, however, could separate these functions to separate physical devices so that the encoder device has a separate chassis and is implemented with separate hardware than the access point device. That is, access point device 110 may or may not coincide with the encoder device, as desired. Further, it is not necessary that the video production device 130 be located within the environment 102, since Internet or other communications may allow the video production control to occur from other locations, as desired. Video production device 130 could be located within the environment 102, however, and its location may be presented with the other location data if desired.

In various embodiments, an interface 100 graphically represents a map or other physical layout of the environment 102 in which the access point 110, capture devices 160A-F and/or control device 130 interoperate. To that end, interface 100 may be presented within a video production or similar application executed by production system 130 or the like. The information presented in interface 100 may be visually overlaid upon a map, drawing, camera image or other graphic if desired, if such graphics are available. Imagery may be imported into a control application using standard (or non-standard) image formats, as desired. In other embodiments, the control application or the like could provide a graphical interface that allows the producer/user to draw an image of the physical environment, as desired. If the video production is intended to show a basketball game, for example, it may be desirable to draw the court floor, sidelines, baskets, etc. for later reference. If graphical imagery is not available, however, the relative locations of the different entities operating within the system may still be useful.

Various embodiments allow the producer or another user to identify restricted areas 105 of the environment 102, as desired. Restricted areas 105 may represent, for example, a stage or sports court where video capture or other equipment should not travel. If environment 102 represents a sports arena or gymnasium, for example, it may be desirable to restrict cameras or access points from travelling onto the basketball court itself to prevent interference with the game. Restricted areas 105 therefore represent spatial areas where movement is not allowed. These areas may be defined by the user through the use of an interface within a production application, or in any other manner. In various embodiments, the restricted areas 105 may be defined in three-dimensional terms to include a height parameter. That is, a drone or the like could be allowed to fly over a restricted area 105 at an appropriate height. Other embodiements could define the restricted area 105 in two-dimensional terms and/or could define the area 105 with a very large (or infinite) height restriction if flight or other overhead passage is not allowed. Restricted areas 105 may also have time parameters, if desired, or a system operator may be able to disable the restrictions if desired. A camera may be allowed onto a court or field during a time out or other break in the action, for example.

Locations of different devices no, 130, 160A-F operating within the area may be determined and presented in any manner. Locations may be based upon global positioning system (GPS) coordinates measured by the different components, for example. Locations could be additionally or alternately triangulated from wi-fi zones or cellular networks, or determined in any other manner. Still other embodiments could allow a camera operator or other user to manually specify a location, as desired.

Location information is transmitted to the access point 110 and/or to the production system 130 on any regular or irregular temporal basis, and interface 100 is updated as desired so that the producer user can view the locations of the various devices. Location information can be useful in knowing which camera angles or shots are available so that different cameras can be selected for preview imagery and/or for the output stream. If a video production application is only capable of displaying four potential video feeds, for example, but more than four cameras are currently active in the system, then the locations of the various cameras may be helpful in selecting those cameras most likely to have content feeds that are of interest. Location information can also be useful in determining communication signal strength, as described more fully below. Other embodiments may make use of additional benefits derived from knowing and/or presenting the locations of devices operating within the system, as more fully described herein.

Some implementations may determine and present an “optimal” location 107 for the access point 110 so that network coverage is optimized for some or all of the video capture devices 160A-F. “Optimal” location 107 may not necessarily be optimal in a purely mathematical sense, but generally the location 107 may be better than the current position of the access point 110, and/or may be the best available position at the time. Optimal locations 107 may be computed based best average connection to the active capture devices 160, for example, or based upon best average connection to the devices 160 that are current being previewed.

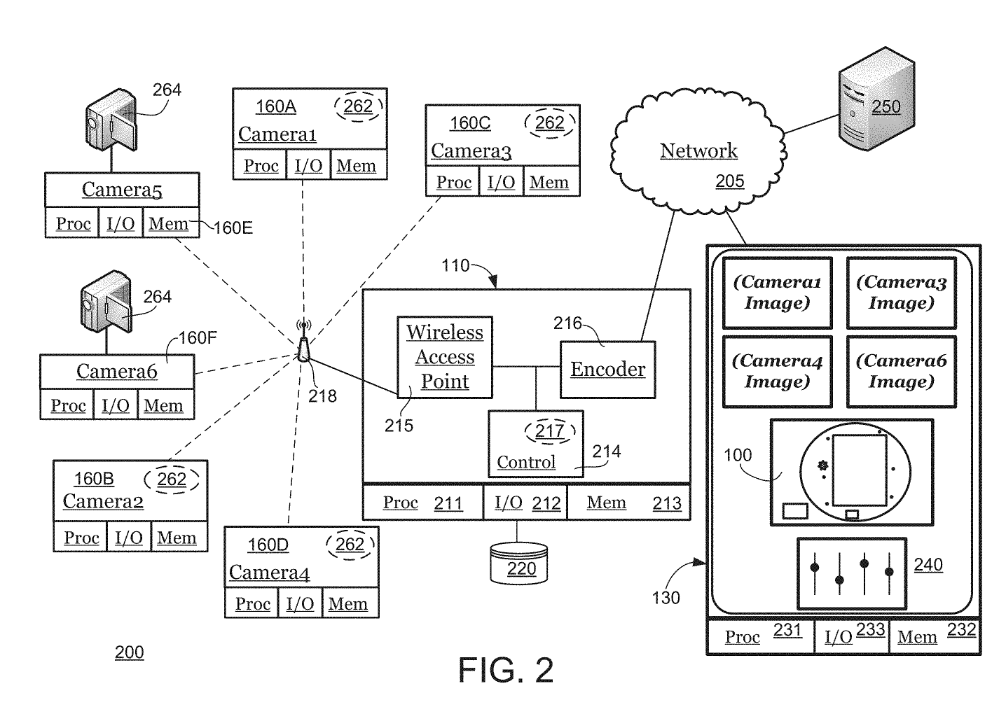

Some embodiments may alternately or additionally determine optimal locations 107 for the capture devices 160 themselves. Locations may be determined manually by a producer/user, or automatically computed by the control application 130 to recommend better locations. The better location may be transmitted to an application (e.g., application 262 in FIG. 2) executing on the capture device, for example, to instruct the operator to move to a different location for better camera views and/or better wireless connectivity. Such instructions may direct the presentation of an arrow or similar pointer that is displayed in a camera viewfinder that directs the operative to move in a particular direction. Other embodiments may use audio or text instructions to a camera operator and/or other communications techniques to send instructions to the operator, as desired.

Interface 100 therefore graphically represents the physical space 102 surrounding the production of a video. The absolute or relative locations of video capture devices 160A-F, access points 110 and/or production devices 130 are graphically presented, along with any restricted areas 105 that should not be entered. Improved or “optimal” locations for one or more devices 110, 160A-F may be determined and presented, as desired. The particular imagery illustrated in FIG. 1 is intended to be simple for illustration purposes. A practical implementation may display similar information in a manner that looks very different, that includes additional information, that represents similar information in a different manner, that has a different scale, or that is otherwise different from the example illustrated in FIG. 1.

FIG. 2 shows an example of a video production system 200 that could be used to produce a video program based upon selected inputs from multiple input video feeds. In the illustrated example, system 200 suitably includes a video processing device 110 that provides a wireless access point and appropriate encoding hardware to encode video programming based upon instructions received from control device 130. The encoded video program may be initially stored as a file on an external storage (e.g., a memory card, hard drive or other non-volatile storage) 220 for eventual uploading to a hosting or distribution service 250 operating on the Internet or another network 205. Services 250 could include, for example, YouTube, Facebook, Ustream, Twitch, Mixer and/or the like. As noted above, equivalent embodiments could split the encoding and access point functions of video processing device 110, as desired.

Video production system 110 suitably includes processing hardware such as a microprocessor 211, memory 212 and input/output interfaces 213 (including a suitable USB or other interface to the external storage 220). The example illustrated in FIG. 2 shows video production system 110 including processing logic to implement an IEEE 802.11, 802.14 or other wireless access point 215 for communicating with any number of video capture devices 160A-F, which could include any number of mobile phones, tablets or similar devices executing a video capture application 262, as desired. Video capture devices 160 could also include one or more conventional video cameras 264 that interact with video production system 110 via an interface device that receives DVI or other video inputs and transmits the received video to the video production system 110 via a Wi-fi, Bluetooth or other wireless network, as appropriate. Other embodiments could facilitate communications with any other types of video capture devices in any other manner.

Video encoding system 110 is also shown to include a controller 214 and encoder 216, as appropriate. Controller 214 and/or encoder 216 may be implemented as software logic stored in memory 212 and executing on processor 211 in some embodiments. Controller 214 may be implemented as a control application executing on processor 211, for example, that includes logic 217 for implementing the location and/or communications quality analysis based upon any number of different factors. An example technique for determining signal quality could consider modulation coding scheme, received signal strength indication (RSSI) data, signal-to-noise ratio (SNR) and/or any number of other factors, as desired. Any other techniques or processes could be equivalently used. Other embodiments may implement the various functions and features using hardware, software and/or firmware logic executing on other components, as desired. Encoder 216, for example, may be implemented using a dedicated video encoder chip in some embodiments.

In various embodiments, video processing device 110 operates in response to user inputs supplied by control device 130. Control device 130 is any sort of computing device that includes conventional processor 231, memory 232 and input/output 233 features. Various embodiments could implement control device 130 as a tablet, laptop or other computer system, for example, or as a mobile phone or other computing device that executes a software application 240 for controlling the functions of system 200. Typically, control device 130 interacts with video processing device 110 via a wireless network 205, although wired connections could be equivalently used. Although FIG. 2 shows network 205 as a separate from the wireless connections between processing device 110 and video capture devices 130, in practice the same WiFi or other networks could be used if sufficient bandwidth is available. Other embodiments may use any other network configuration desired, including any number of additional or alternate networks or other data links.

The example illustrated in FIG. 2 shows control application 240 having an interface that shows various video feeds received from some or all of the image collection devices 160A-F, and that lets the user select an appropriate feed to encode into the finished product. Application 240 may include other displays to control other behaviors or features of system 200, as desired. In the illustrated example, a graphical interface 100 illustrating an environment such as that described in conjunction with FIG. 1 is shown at the same time as the captured imagery, albeit in a separate portion of the display 130. In practice, however, interface 100 may equivalently be presented on a separate screen or image than the captured content for larger presentation or ease of viewing. Interface 100 could be equivalently presented in a dashboard or similar view that presents system or device status information, as desired. Again, the presentation and appearance of the interface 100 may be very different in other embodiments, and may incorporate any different types of information or content arranged in any manner.

In operation, then, a user acting as a video producer would use application 240 to view the various video feeds that are available from one or more capture devices 160A-F. The selected video feed is received from the capture device 160 by video processing device 110. The video processing device 110 suitably compresses or otherwise encodes the selected video in an appropriate format for eventual viewing or distribution, e.g., via an Internet or other network service 250. Application 140 executing on production device 130 suitably receives location information from the access point device 130 and presents the location data in an interface 100 as desired. Again, the manner in which the information is displayed or otherwise presented may be different from that shown in the figures, and may vary dramatically from embodiment to embodiment.

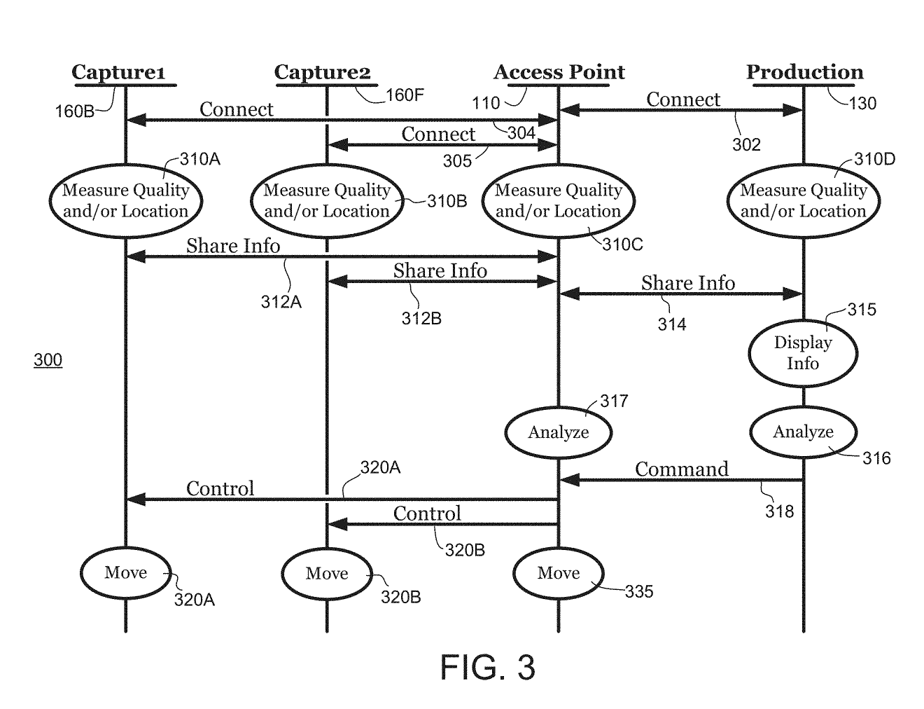

FIG. 3 illustrates various example processes that could be automatically executed by capture devices 160, access point 110 and/or production system 130 as desired. FIG. 3 also shows various data flows of information that could be exchanged in an example process 300, as desired. Other embodiments may be organized to execute in any other manner, with the various functions and messages shown in FIG. 3 being differently organized and/or executed by other devices, as appropriate.

Communications are initiated and established in any manner (functions 302, 304, 305). As noted above, communications 304, 305 between capture devices 160A,F (respectively) may be established using a Wi-fi or network hosted by the access point device 110. Communications between the access point device 110 and the control device 130 may be established over the same network, or over a separate wireless or other connection, as desired.

Quality of communications between the access point 110 and the capture devices 160 is monitored in any manner (functions 310A-C). The particular information that is gathered may vary from embodiment to embodiment. In one example, the received signal strength indicator (RSSI) values from the network interface cards (NICs) or other wireless interfaces could be used to estimate signal strength. Other embodiments could additionally or alternately evaluate signal-to-noise ratios (SNRs), measured noise or interference on the wireless channel, and/or any number of other parameters. One example of a process to measure communications quality between the access point 110 and the various capture device 160 “clients” considers RSSI and/or SNR data measured by each client, although other techniques could use any other techniques, including techniques based upon completely different factors. Other embodiments simply assume that signal strength and/or quality is proportional to the distances between the sending and receiving nodes, as determined from GPS or other positions.

Although the example illustrated in FIG. 3 shows each node 160 computing its own communication quality, this may not be possible or even desirable in practice. Some mobile devices may not allow access to RSSI or similar low-level information, or other impediments may exist (e.g., limited processing resources on mobile devices, especially during video capture). Some implementation may equivalently omit signal quality analysis on the mobile devices 160, and instead perform such analysis by the access point device 110 on communications sent and received with each device. Quality of communication between access point 110 and control device 130 (function 310D) may also be measured, if desired, or omitted as appropriate. Server side quality analysis could also be used in conjunction with client side analysis, if desired, to provide redundancy and improved accuracy, if desired.

Functions 310A-D may also involve determining a location of the device. Location may be determined based upon GPS, triangulated wifi or cellular data, through dead reckoning using an interferometer or compass, and/or any other manner. Location data may include a height or altitude, if desired, so that the producer can be made aware of the availability of aerial shots, or for any other purpose. Some embodiments may also permit drones or the like to enter restricted areas 105, provided that the altitude of the device is sufficient that it will not interrupt the game, performance or other captured subject matter.

Location and/or signal quality information gathered by the various devices 160 and/or 130 is reported back to the access point 110 (functions 312). Information collected by access point 110 may be reported to the control application 240 of control device 130 (function 314) for presentation to the producer/user as interface 100 or the like (function 315), or for further analysis as desired (function 316).

In some embodiments, the reporting function 312 also involves the access point 110 reporting signal quality data back to the capture device 160 for presentation to the user, or for any other purpose. If device 160 is not able to measure its own communications quality data, then it may be helpful to report this information back and to present the information on a display associated with the device 160 so that a camera operator or other user can identify low quality conditions and respond accordingly (e.g., by moving closer to the access point 110).

Location information may be displayed on the control device 130 in any manner (function 315). Absolute or relative positions of the various devices 110, 160 may be presented on a map or the like, for example, similar to interface 100 described above. Again, other embodiments may present the information in any other manner.

Location information and/or communications quality information about one or more devices 110, 130, 160 may be analyzed in any manner. The example of FIG. 3 shows that analysis could be performed by the access point 110 (function 317) and/or by the control device 130 (function 316), depending upon the implementation and the availability of sufficient computing resources. Analysis 316, 317 could involve highlighting devices 160 having weak signals (e.g., using different colors or icons on interface 100), for example. Other embodiments could analyze the locations and/or communications quality data of the various devices to identify “optimal” (or at least better) locations for the access point 110 and/or one or more capture devices 160, as desired. These locations will typically be constrained by the restricted areas 105 identified above. Restricted areas may be considered in two or three dimensions, if desired, so that drones or other aerial devices are allowed to enter zones that would not be available to ground devices without interfering with the captured action.

One technique for determining a better location for an access point 110 considers the locations and/or quality of communications for multiple active capture devices 160A-F. In this example, a location is identified that is relatively equidistant to the various cameras (e.g., closest to an average latitude/longitude; further embodiments could adapt the average using centroid or similar analysis that gives more active cameras more weight than lesser used cameras). The better location could be constrained by the restricted areas 105 described above, or by any number of other factors. If signal interference has been identified in the “better” location, for example, that location can be avoided in future analysis 316, 317. Locations that are discovered to have relatively high signal interference (e.g., measured interference greater than an absolute or relative threshold value) could be considered in the same manner as restricted areas 105, if desired, so that devices 110, 160 are not directed into that area in the future.

Other embodiments may attempt to determine the better location for an access point 110 by focusing solely on the currently-active capture device 160. In this example, the better location 107 may be determined to be as close to the active device as possible without entering a restricted areas or area with known signal interference. A recommended location 107 may be tempered by distance (e.g., too great of a distance to cover in available time), interfering physical obstacles, radio interference and/or other factors as desired.

The better location(s) 107 of the access point 110 and/or any number of video capture devices 160 may be presented on the control interface of application 240 (function 315), transmitted to the devices themselves for display or execution (functions 320), and/or processed in any other manner. Various embodiments may allow control device 130 to provide commands 318 to the access point 110 for relaying to devices 160, as appropriate. Such commands may reflect user instructions, automated commands based upon analysis 316, and/or any other factors as desired.

In some embodiments, access point 110 and/or one or more capture devices 160 may be automatically moveable to the newly-determined “better” locations identified by analysis 316 and/or analysis 317. If a camera is mounted on a drone or other vehicle, for example, then the camera can be repositioned based upon commands 320 sent to the device 160 (function 330A-B). Similarly, if access point 110 is moveable by drone or other vehicle, then it may move itself (function 335) to the better location, as desired. Movement may take place by transmitting control instructions 320 from the access point 110 to the capture device 160 via the same links used for video sharing, if desired. Equivalently, commands 320 may be transmitted via a separate radio frequency (RF), infrared (IR) or other connection that is receivable by a motor, controller or other movement actuator associated with the controlled capture device 160 as desired.

The various concepts and examples described herein may be modified in any number of different ways to implement equivalent functions and structures in different settings. The term “exemplary” is used herein to represent one example, instance or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. An automated process executable by a video production device that produces a video production stream of an event occurring within a physical space from a plurality of video input streams that are each captured by different video capture devices located within the physical space, the automated process comprising:
receiving, from each of the different video capture devices, the video input stream obtained from the video capture device and location information describing a current location of the video capture device;
presenting a first output image by the video production device that graphically represents the current locations of each of the video capture devices operating within the physical space;
presenting a second output image by the video production device that presents the video input streams from at least some of the different video capture devices;
receiving inputs from a user of the video production device to select one of the video input streams for inclusion in the video production stream; and
responding to the inputs from the user of the video production device to create the video production stream as an output for viewing.

2. The automated process of claim 1 further comprising analyzing the current locations of the video capture devices to determine an optimal location of the video production device relative to the video capture devices, and wherein the first output image comprises an indication of the optimal location within the physical space.

3. The automated process of claim 2 further comprising directing a movement of the video production device from a current position to the optimal position within the physical environment.

4. The automated process of claim 2 wherein the optimal location is based upon a centroid of the distances to the different video capture devices.

5. The automated process of claim 2 wherein the analyzing further comprises identifying a restricted area in the physical space in which the video production device is not allowed to enter.

6. The automated process of claim 5 wherein the restricted area is defined in terms of a three dimensional space having a minimum height so that the video production device is allowed to enter the restricted area above the minimum height.

7. The automated process of claim 1 wherein the first and second output images are both presented within the same display screen.

8. The automated process of claim 1 wherein the first and second output images are presented in separate display screens.

9. The automated process of claim 1 wherein the video production system comprises a processor, memory and display, wherein the processor executes program logic stored in the memory to generate a user interface on the display that comprises the first and second output images.

10. A video production system for producing a video production stream of an event occurring within a physical space, the video production system comprising:
a plurality of video capture devices located within the physical space, wherein each of the video capture devices is configured to capture an input video stream;
an access point configured to establish a wireless communications connection with each of the video capture devices; and
a video production device in communication with the access point to receive, from each of the plurality of video capture devices, the input video stream and location information describing a location of the video capture device within the physical environment;
wherein the video production device is further configured to present an interface on a display that comprises a first output image that graphically represents the current locations of each of the video capture devices operating within the physical space and a second output image by that presents the video input streams from at least some of the video capture devices.

11. The video production system of claim 10 wherein the video production device is further configured to receive inputs from a user of the video production device to select one of the video input streams for inclusion in the video production stream, and to respond to the inputs from the user of the video production device to create the video production stream as an output for viewing.

12. The video production system of claim 10 wherein the video production device is further configured to analyze the current locations of the video capture devices to determine an optimal location of the video production device relative to the video capture devices, and wherein the first output image comprises an indication of the optimal location within the physical space.

13. The video production system of claim 10 further comprising directing a movement of the video production device from a current position to the optimal position within the physical environment.

14. The video production system of claim 12 wherein the optimal location is based upon a centroid of the distances to the different video capture devices.

15. The video production system of any of claim 10 wherein the video production system is further configured to determine an optimal location of at least one of the video capture devices based upon the location information and a location of the access point, and to provide an instruction to the video capture device directing the video capture device toward the optimal location of the video capture device.
